(19) United States
(12) Patent Application Publication
(10) Pub. No.: US 2015/0036033 A1
(43) Pub. Date: Feb. 5, 2015

(54) SOLID-STATE IMAGING DEVICE

(71) Applicant: Kabushiki Kaisha Toshiba, Minato-ku (JP)

(72) Inventors: Yukiyasu TATSUZAWA, Yokohama-shi (JP); Kazuhiro HIWADA, Yokohama-shi (JP); Tatsuji ASHITANI, Yokohama-shi (JP)

(73) Assignee: Kabushiki Kaisha Toshiba, Minato-ku (JP)

(21) Appl. No.: 14/197,455

(22) Filed: Mar. 5, 2014

(30) Foreign Application Priority Data
Jul. 31, 2013 (JP) 2013-159842

(51) Int. Cl. H04N 5/369

(52) U.S. Cl. CPC H04N 5/369
USPC 348/302

(57) ABSTRACT

According to one embodiment, in a pixel array unit, pixels configured to accumulate photoelectrically-converted charges are arranged in a matrix shape. A binning control unit performs control to lump together several pixels among the pixels between different lines of the pixel array unit. A frame-read control unit thins out and reads the lines to vary thinning positions of the lines lumped together by the binning control unit among two or more frames. A reconfiguration processing unit combines the two or more frames, in which the thinning positions are different, to thereby configure one frame.

### CROSS-REFERENCE TO RELATED APPLICATIONS

This application is based upon and claims the benefit of priority from Japanese Patent Application No. 2013-159842, filed on Jul. 31, 2013; the entire contents of which are incorporated herein by reference.

### FIELD

Embodiments described herein relate generally to a solid-state imaging device.

### BACKGROUND

In a solid-state imaging device, there is a demand for an ultra high speed moving image such as a slow motion moving image. There is also a digital camera that can pick up a moving image at a frame rate of 1000 fps.

### BRIEF DESCRIPTION OF THE DRAWINGS

FIG. 1 is a block diagram of the schematic configuration of a solid-state imaging device according to a first embodiment;

FIG. 2 is a circuit diagram of a configuration example of a pixel of the solid-state imaging device shown in FIG. 1;

FIG. 3 is a timing chart of voltage waveforms of sections of the pixels shown in FIG. 2;

FIG. 4A is a diagram of an example of binning processing and thinning read in the solid-state imaging device shown in FIG. 1;

FIG. 4B is a diagram of an example of frames subjected to the binning processing and the thinning read in the solid-state imaging device shown in FIG. 1;

FIG. 4C is a diagram for explaining a reconfiguration method for the frames shown in FIG. 4B;

FIGS. 5A and 5B are diagrams for explaining a frame reconfiguration method of the solid-state imaging device shown in FIG. 1;

FIGS. 6A and 6B are diagrams for explaining another example of the frame reconfiguration method of the solid-state imaging device shown in FIG. 1;

FIGS. 7A and 7B are diagrams for explaining still another example of the frame reconfiguration method of the solid-state imaging device shown in FIG. 1;

FIG. 8 is a diagram for explaining still another example of the frame reconfiguration method of the solid-state imaging device shown in FIG. 1;

FIG. 9 is a diagram for explaining an example of a calculation method for an inter-frame error used in the frame reconfiguration of the solid-state imaging device shown in FIG. 1;

FIG. 10 is a diagram for explaining a frame read method of a solid-state imaging device according to a second embodiment;

FIG. 11 is a diagram for explaining binning processing and a thinning read method of a solid-state imaging device according to a third embodiment;

FIG. 12 is a diagram for explaining binning processing and a thinning read method of a solid-state imaging device according to a fourth embodiment;

FIG. 13 is a diagram for explaining binning processing and a thinning read method of a solid-state imaging device according to a fifth embodiment;

FIG. 14 is a diagram for explaining binning processing and a thinning read method of a solid-state imaging device according to a sixth embodiment; and

FIG. 15 is a block diagram of the schematic configuration of a digital camera applied with a solid-state imaging device according to a seventh embodiment.

### DETAILED DESCRIPTION

In general, according to one embodiment, a solid-state imaging device includes a pixel array unit, a binning control unit, a frame-read control unit, and a reconfiguration processing unit. In the pixel array unit, pixels configured to accumulate photoelectrically-converted charges are arranged in a matrix shape. The binning control unit performs control to lump together several pixels among the pixels between different lines of the pixel array unit. The frame-read control unit thins out and reads the lines to vary thinning positions of the lines lumped together by the binning control unit among two or more frames. The reconfiguration processing unit combines the two or more frames, in which the thinning positions are different, to thereby configure one frame.

Exemplary embodiments of a solid-state imaging device will be explained below in detail with reference to the accompanying drawings. The present invention is not limited to the following embodiments.

### First Embodiment

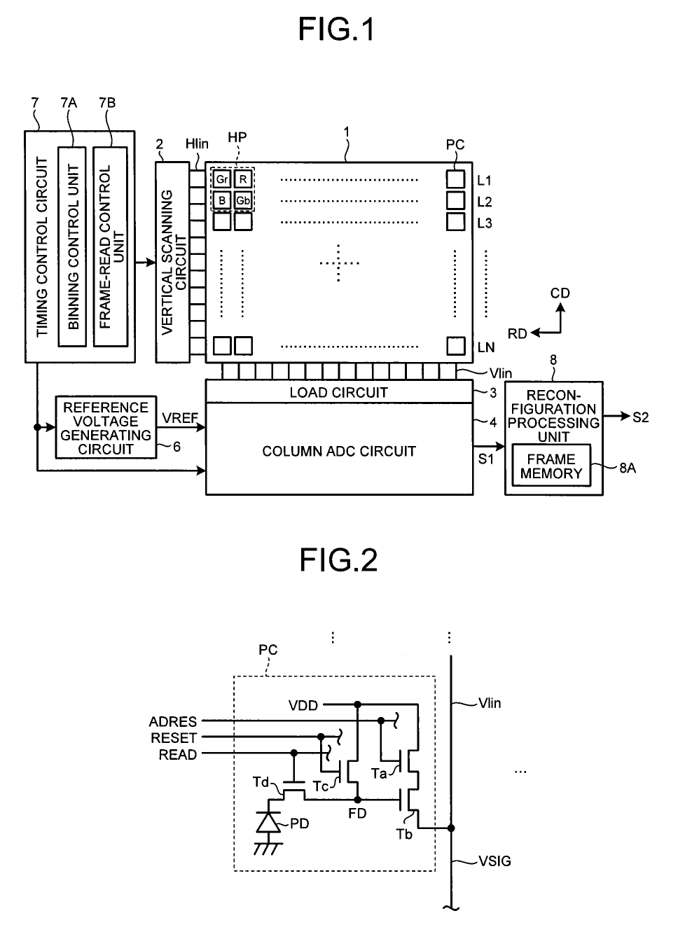

FIG. 1 is a block diagram of the schematic configuration of a solid-state imaging device according to the first embodiment.

In FIG. 1, a pixel array unit 1 is provided in the solid-state imaging device. In the pixel array unit 1, pixels PC configured to accumulate photoelectrically-converted charges are arranged in a matrix shape in a row direction RD and a column direction CD. In the pixel array unit, 1N (N is an integer equal to or lager than 2) lines L1 to LN are provided. In the pixel array unit 1, horizontal control lines Hlin for performing read control for pixels PC are provided in the row direction RD and vertical signal lines Vlin for transmitting signals read out from the pixels PC are provided in the column direction CD.

In the solid-state imaging device, a vertical scanning circuit 2 configured to scan read target pixels PC in the vertical direction, a load circuit 3 configured to perform a source follower operation with the pixels PC to thereby read out signals from the pixels PC to the vertical signal lines Vlin column by column, a column ADC circuit 4 configured to detect signal components of the pixels PC column by column in a CDS, a reference voltage generating circuit 6 configured to output a reference voltage VREF to the column ADC circuit 4, and a timing control circuit 7 configured to control timing for readout from and accumulation in the pixels PC are provided. As the reference voltage VREF, a ramp wave can be used.

In the pixel array unit 1, to colorize a picked-up image, a Bayer array HP including four pixels PC as one set can be formed. In the Bayer array HP, two pixels for green Gr and Gb are arranged in one diagonal direction and one pixel for red R and one pixel for blue B are arranged in the other diagonal direction.

In the timing control circuit 7, a binning control unit 7A and a frame read control unit 7B are provided. The binning control unit 7A performs control to lump together several pixels PC among the pixels PC between different lines of the pixel array unit 1. The frame-read control unit 7B thins out and reads lines to vary thinning positions of the lines lumped together by the binning control unit 7A among two or more frames.

In the solid-state imaging device, a reconfiguration processing unit 8 configured to combine two or more frames, in which the thinning positions are different, to thereby configure one frame is provided. In the reconfiguration processing unit 8, a frame memory 8A configured to store an output signal S1 of the column ADC circuit 4 frame by frame is provided.

The vertical scanning circuit 2 scans the pixels PC in the vertical direction in the vertical scanning circuit 2 to thereby select the pixel PC in the row direction RD. The load circuit 3 performs a source follower operation with the pixel PC to thereby transmit a signal read from the pixel PC via the vertical signal line Vlin and send the signal to the column ADC circuit 4. The reference voltage generating circuit 6 sets a ramp wave as the reference voltage VREF and sends the ramp wave to the column ADC circuit 4. The column ADC circuit 4 performs a count operation for a clock until a signal level and a reset level read out from the pixel PC coincide with a level of the ramp wave. The column ADC circuit 4 calculates a difference between the signal level and the reset level at that point to thereby detect signal components of the pixels PC in the CDS and outputs the signal components as the output signal S1.

The binning control unit 7A performs control to read out charges of the pixels PC between different lines of the pixel array unit 1 all together. That is, the binning control unit 7A can perform charge addition binning between the different lines of the pixel array section 1. For example, when it is assumed that K (K is an integer equal to or larger than 2) lines are read all together, it is possible to multiply sensitivity with K and multiply an angle of view with K.

The frame-read control unit 7B thins out and reads lines to vary thinning positions of the lines lumped together by the binning control unit 7A among two or more frames. For example, when it is assumed that thinning positions are circulated between two frames A and B, odd number lines after binning can be thinned out in the frame A and even number lines after binning can be thinned out in the frame B. When the number of frames in which thinning positions are circulated is represented as M (M is an integer equal to or larger than 2), it is possible to multiply a frame rate with M. When an exposure period of one frame is represented as EX, one frame can be read in time of EX/M to make the exposure period to overlap an exposure period of another frame in time of EX*(M−1)/M. Consequently, compared with sensitivity obtained when exposure times do not overlap between frames, it is possible to multiply the sensitivity with M.

The reconfiguration processing unit 8 combines two or more frames, in which the thinning positions are different, to thereby configure one frame and outputs the frame as an output signal S2. For example, when it is assumed that the two frames A and B are combined to configure one frame, it is possible to maintain an angle of view without deteriorating a frame rate.

That is, the charge addition binning is performed in the K lines, thinning positions are circulated in the M frames, exposure periods are set to overlap among the frames, and the frames are reconfigured. Consequently, at the same frame rate, it is possible to multiply the sensitivity with K×M and multiply the angle of view with K. Alternatively, it is possible to multiply the sensitivity with K, multiply the angle of view with K, and multiply the frame rate with M.

FIG. 2 is a circuit diagram of a configuration example of a pixel of the solid-state imaging device shown in FIG. 1.

In FIG. 2, in the pixel PC, a photodiode PD, a row selection transistor Ta, an amplifier transistor Tb, a reset transistor Tc, and a readout transistor Td are provided. A floating diffusion FD is formed as a detection node at a connection point of the amplifier transistor Tb, the reset transistor Tc, and the readout transistor Td.

A source of the readout transistor Td is connected to the photodiode PD. A read signal READ is input to a gate of the readout transistor Td. A source of the reset transistor Tc is connected to a drain of the readout transistor Td. A reset signal RESET is input to a gate of the reset transistor Tc. A drain of the reset transistor Tc is connected to a power supply potential VDD. A row selection signal ADRES is input to a gate of the row selection transistor Ta. A drain of the row selection transistor Ta is connected to the power supply potential VDD. A source of the amplifier transistor Tb is connected to the vertical signal line Vlin. A gate of the amplifier transistor Tb is connected to the drain of the readout transistor Td. A drain of the amplifier transistor Tb is connected to a source of the row selection transistor Ta.

The horizontal control line Hlin shown in FIG. 1 can transmit the read signal READ, the reset signal RESET, and the row selection signal ADRES to the pixels PC row by row.

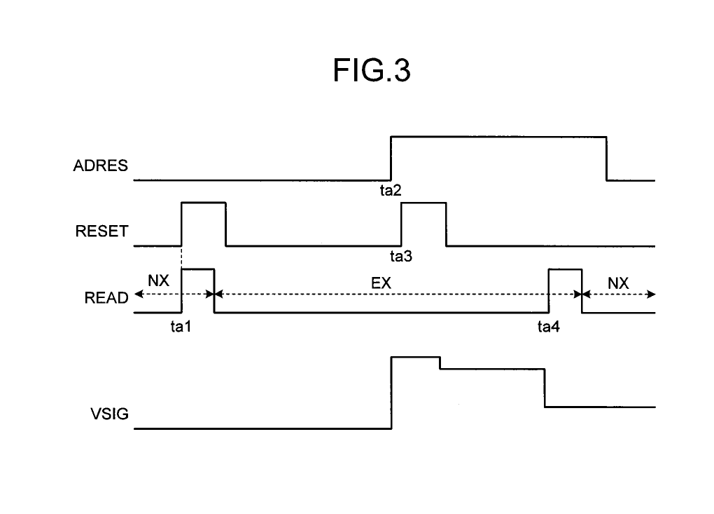

FIG. 3 is a timing chart of voltage waveforms of the sections of the pixel shown in FIG. 2.

In FIG. 3, when the row selection signal ADRES is at a low level, the row selection transistor Ta changes to an OFF state. A pixel signal VSIG is not output to the vertical signal line Vlin. At this point, when the read signal READ and the reset signal RESET change to a high level (ta1), the readout transistor Ta is turned on. Charges accumulated in the photodiode PD in a non-exposure period NX are discharged to the floating diffusion FD. The charges are discharged to the power supply potential VDD via the reset transistor Tc.

After the charges accumulated in the photodiode PD in the non-exposure period NX are discharged to the power supply potential VDD, when the read signal READ changes to the low level, the photodiode PD starts accumulation of effective signal charges and shifts from the non-exposure period NX to an exposure period EX.

Subsequently, when the row selection signal ADRES changes to the high level (ta2), the row selection transistor Ta of the pixel PC is turned on. The power supply potential VDD is applied to the drain of the amplifier transistor Tb.

When the reset signal RESET changes to the high level in an ON state of the row selection transistor Ta (ta3), the reset transistor Tc is turned on. Excess charges generated by a leak current or the like in the floating diffusion FD are reset. A voltage corresponding to a reset level of the floating diffusion FD is applied to the gate of the amplifier transistor Tb. The voltage of the vertical signal line Vlin follows the voltage applied to the gate of the amplifier transistor Tb, whereby the pixel signal VSIG at the reset level is output to the vertical signal line Vlin.

The pixel signal VSIG at the reset level is input to the column ADC circuit 4 and compared with the reference voltage VREF. The pixel signal VSIG at the reset level is converted into a digital value based on a result of the comparison and retained.

Subsequently, when the read signal READ changes to the high level in the ON state of the row selection transistor Ta of the pixel PC (ta4), the readout transistor Td is turned on. Charges accumulated in the photodiode PD in the exposure period EX are transferred to the floating diffusion FD. A voltage corresponding to a read level of the floating diffusion FD is applied to the gate of the amplifier transistor Tb. The voltage of the vertical signal line Vlin follows the voltage applied to the gate of the amplifier transistor Tb, whereby the pixel signal VSIG at a signal read level is output to the vertical signal line Vlin.

The pixel signal VSIG at the signal read level is input to the column ADC circuit 4 and compared with the reference voltage VREF. A difference between the pixel signal VSIG at the reset level and the pixel signal VSIG at the signal read level is converted into a digital value based on a result of the comparison and output as the output signal S1 corresponding to the exposure period EX.

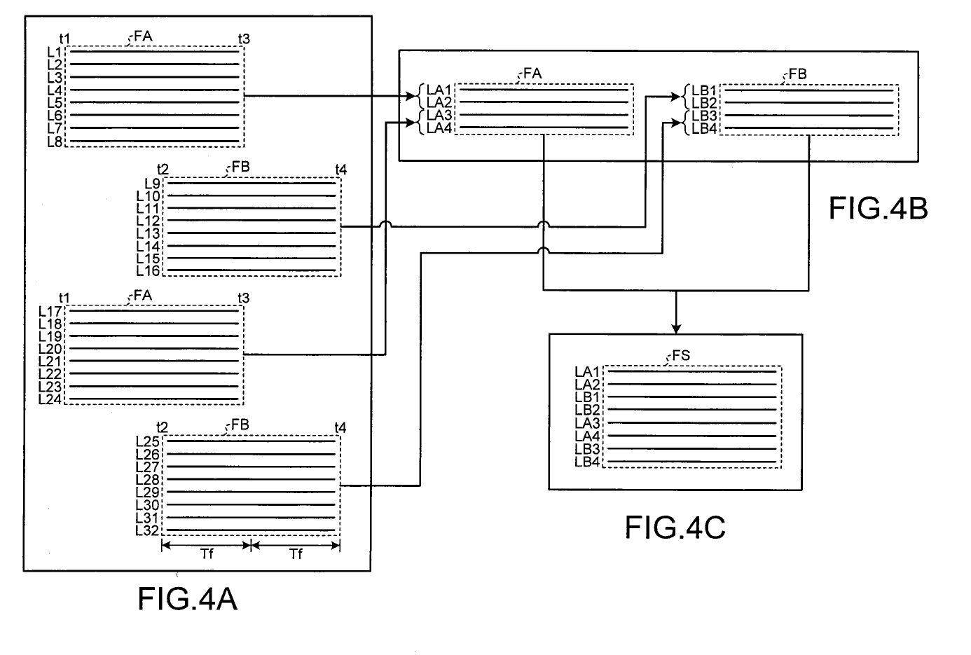

FIG. 4A is a diagram of an example of binning processing and thinning read in the solid-state imaging device shown in FIG. 1. FIG. 4B is a diagram of an example of frames subjected to the binning processing and the thinning read in the solid-state imaging device shown in FIG. 1. FIG. 4C is a diagram for explaining a reconfiguration image for the frames shown in FIG. 4B. In FIGS. 4A to 4C, as an example, K=4 and M=2. Further, in the examples shown in FIGS. 4A to 4C, binning, thinning, and reconfiguration are performed to maintain a correspondence relation among the colors of the Bayer array HP.

In FIGS. 4A and 4B, in a frame FA, lines LA1 and LA2 are generated based on binning processing for lines L1 to L8. Lines LA3 and LA4 are generated based on binning processing for lines L17 to L24. The lines LA1 to LA4 are sequentially read, whereby the frame FA is read. In a frame FB, lines LB1 and LB2 are generated based on binning processing for lines L9 to L16. Lines LB3 and LB4 are generated based on binning processing for lines L25 to L32. After the frame FA is read, the lines LB1 to LB4 are sequentially read, whereby the frame FB is read. The frames FA and FB can be stored in the frame memory 8A.

The line LA1 can be generated by charge addition binning for the lines L1, L3, L5, and L7. The line LA2 can be generated by charge addition binning for the lines L2, L4, L6, and L8. The line LA3 can be generated by charge addition binning for the lines L17, L19, L21, and L23. The line LA4 can be generated by charge addition binning for the lines L18, L20, L22, and L24. The line LB1 can be generated by charge addition binning for the lines L9, L11, L13, and L15. The line LB2 can be generated by charge addition binning for the lines L10, L12, L14, and L16. The line LB3 can be generated by charge addition binning for the lines L25, L27, L29, and L31. The line LB4 can be generated by charge addition binning for the lines L26, L28, L30, and L32.

At this point, in the frame FA before the binning, time t1 to t3 can be set as an exposure period and time t2 to t3 can be set as a read period Tf. In the frame FB before the binning, time t2 to t4 can be set as an exposure period and time t3 to t4 can be set as the read period Tf. The time t2 can be set in the center between the time t1 and the time t3. The time t3 can be set in the center between the time t2 and the time t4.

When the frames FA and FB are read, as shown in FIG. 4C, the frames FA and FB are combined to interpolate thinning positions of the frames FA and FB each other, whereby one frame FS is generated. That is, in the frame FS, the first two lines LA1 and LA2 are acquired from the frame FA, the next two lines LB1 and LB2 are acquired from the frame FB, the next two lines LA3 and LA4 are acquired from the frame FA, and the next two lines LB3 and LB4 are acquired from the frame FB.

Consequently, in the examples shown in FIGS. 4A to 4C, it is possible to quadruple sensitivity, quadruple an angle of view, and double a frame rate while maintaining the correspondence relation among the colors of the Bayer array HP. In the examples shown in FIGS. 4A to 4C, a method of binning the four lines and then circulating space information at a cycle of two frames in a time direction is explained. However, it is also possible to bin K lines and then circulate the space information at a cycle of M frames in the time direction.

A frame reconfiguration method is explained below. In the following explanation, as an example, K=1 and M=2.

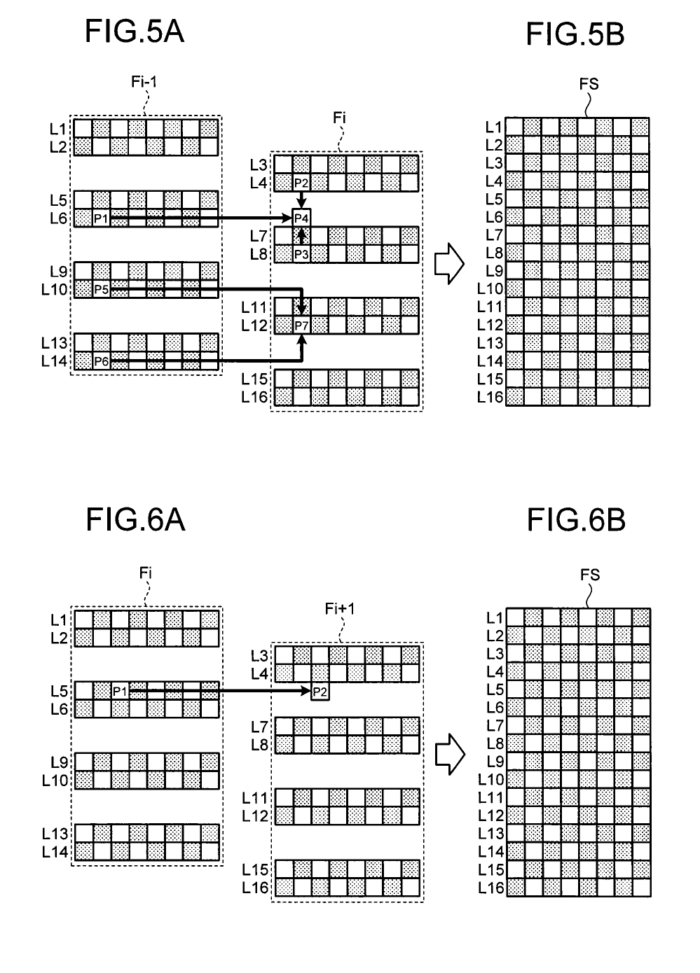

FIGS. 5A and 5B are diagrams for explaining an example of a frame reconfiguration method of the solid-state imaging device shown in FIG. 1.

In FIG. 5A, a past frame Fi−1 includes the lines L1, L2, L5, L6, L9, L10, L13, and L14. A present frame Fi includes the lines L3, L4, L7, L8, L11, L12, L15, and L16. As shown in FIG. 5B, the frames Fi−1 and Fi are combined to configure one frame FS.

A value of a thinned pixel of the present frame Fi is interpolated based on values of same color pixels above and below the present frame Fi and a value of a pixel of the past frame Fi−1 corresponding to the position of the thinned pixel. For example, when a value of a pixel P4 of the present frame Fi is interpolated, a weighted average of values of same color pixels P2 and P3 above and below the present frame Fi and a value of a pixel P1 of the past frame Fi−1 can be calculated.

A value of an original pixel of the present frame Fi is converted based on the value of the original pixel of the present frame Fi and values of same color pixels above and below a pixel of the past frame Fi−1 corresponding to the position of the original pixel. For example, when a value of a pixel P7 of the present frame Fi is converted, a weighted average of the value of the pixel P7 of the present frame Fi and values of pixels P5 and P6 of the past frame Fi−1 can be calculated.

When the frame FS is configured, an image of the frame FS can be blurred by calculating an average of values of peripheral pixels between the frames Fi−1 and Fi. Therefore, it is possible to reduce artifacts such as jaggies and false colors in a high speed moving images.

FIGS. 6A and 6B are diagrams of another example of the frame reconfiguration method of the solid-state imaging device shown in FIG. 1.

In FIG. 6A, the present frame Fi includes the lines L1, L2, L5, L6, L9, L10, L13, and L14. A future frame Fi+1 includes the lines L3, L4, L7, L8, L11, L12, L15, and L16. As shown in FIG. 6B, the frames Fi and Fi+1 are combined to configure one frame FS.

A value of a thinned pixel of the future frame Fi+1 is interpolated based on a value of a pixel of the present frame Fi corresponding to the position of the thinned pixel. For example, when a value of the pixel P2 of the future frame Fi+1 is interpolated, a value of the pixel P1 of the present frame Fi can be used. A value of an original pixel of the future frame Fi+1 is used as it is.

When the frame FS is configured, it is possible to prevent deterioration in resolution by using values of pixels of the frames Fi and Fi+1 as they are. It is possible to set the resolution high compared with the method shown in FIG. 5A.

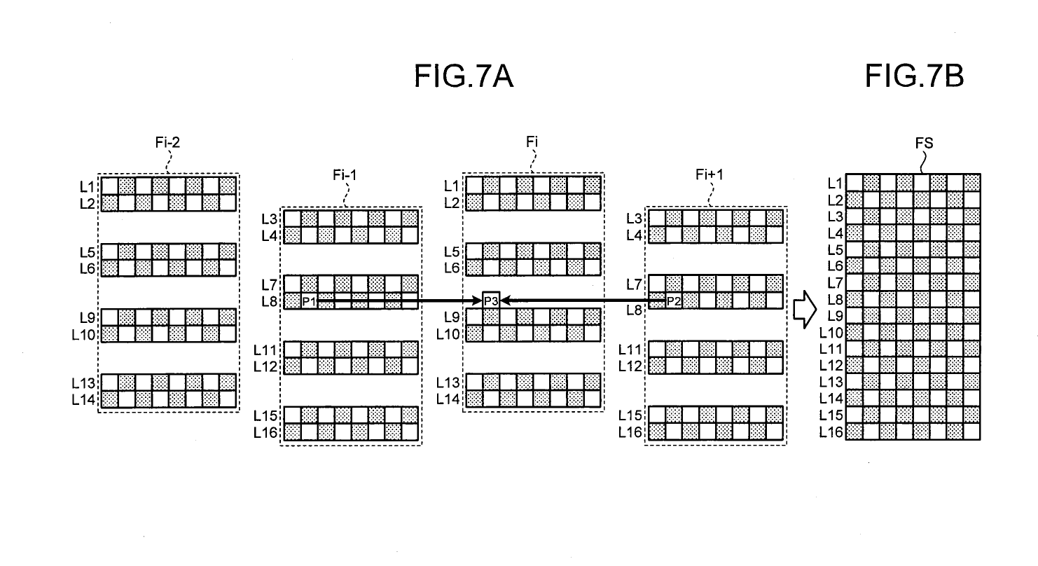

FIGS. 7A and 7B are diagrams of still another example of the frame reconfiguration method of the solid-state imaging device shown in FIG. 1.

In FIG. 7A, a past frame Fi−2 and the present frame Fi include the lines L1, L2, L5, L6, L9, L10, L13, and L14. The past frame Fi−1 and the future frame Fi+1 include the lines L3, L4, L7, L8, L11, L12, L15, and L16. As shown in FIG. 7B, the past frame Fi−1, the present frame Fi, and the future frame Fi+1 are combined to configure one frame FS.

A value of a thinned pixel of the present frame Fi is interpolated based on values of pixels of the past frame Fi−1 and the future frame Fi+1 corresponding to the position of the thinned pixel. For example, when a value of the pixel P3 of the present frame Fi is interpolated, an average of a value of the pixel P1 of the past frame Fi−1 and a value of the pixel P2 of the future frame Fi+1 can be calculated. A value of an original pixel of the present frame Fi is used as it is.

When the frame FS is configured, it is possible to suppress deterioration in resolution by using values of pixels of the frames Fi−1, Fi, and Fi+1. It is possible to set the resolution high compared with the method shown in FIG. 5A.

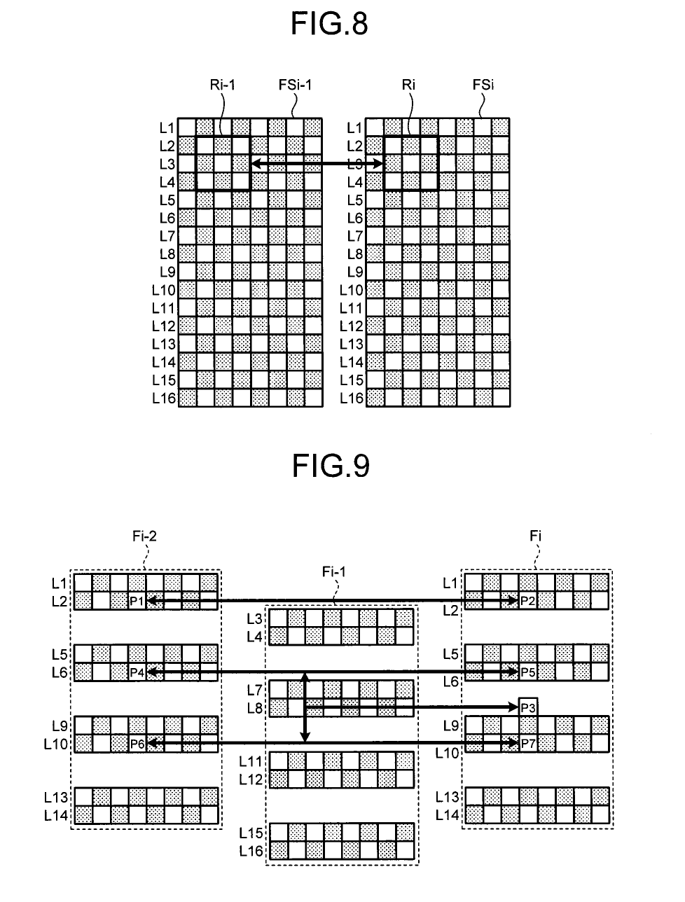

FIG. 8 is a diagram of still another example of the frame reconfiguration method of the solid-state imaging device shown in FIG. 1.

In FIG. 8, a past frame FSi−1 and a present frame FSi shown in FIG. 5B are obtained by the frame reconfiguration method shown in FIG. 5A. A pixel region Ri−1 is extracted from the frame FSi−1. A pixel region Ri is extracted from the frame FSi to correspond to the position of the pixel region Ri−1. In an example shown in FIG. 8, 3×3 pixels are extracted as the pixel regions Ri−1 and Ri. A sum of difference absolute values of values of the pixels is calculated between the pixel regions Ri−1 and Ri. When the sum of the difference absolute values is large, this indicates that the motion of an object is large between the frames FSi−1 and FSi. When the sum of the difference absolute values is small, this indicates that the motion of the object is small between the frames FSi−1 and FSi.

When the sum of the difference absolute values exceeds a predetermined value, the frame reconfiguration method shown in FIG. 5A can be selected. When the sum of the difference absolute values is equal to or smaller than the predetermined value, the frame reconfiguration method shown in FIG. 6A or FIG. 7A can be selected. When the sum of the difference absolute values is within a predetermined range, a frame reconfigured by the method shown in FIG. 5A and a frame reconfigured by the method shown in FIG. 6A or FIG. 7A can be mixed.

Consequently, in a part where the motion of the object is large, it is possible to reduce artifacts while compensating deterioration in resolution with a blur. In a part where the motion of the object is small, it is possible to increase resolution without causing artifacts.

FIG. 9 is a diagram showing an example of a calculation method for an inter-frame error used in frame reconfiguration of the solid-state imaging device shown in FIG. 1.

In FIG. 9, a difference absolute value between a value of a pixel of the past frame Fi−2 and a value of a pixel of the present frame Fi corresponding to the position of the pixel is calculated. For example, a difference absolute value between a value of the pixel P1 of the past frame Fi−2 and a value of the pixel P2 of the present frame Fi is calculated. When the difference absolute value is large, this indicates that the motion of the object is large between the frames Fi−2 and Fi. When the difference absolute value is small, this indicates that the motion of the object is small between the frames Fi−2 and Fi. When the difference absolute value exceeds a predetermined value, the frame reconfiguration method shown in FIG. 5A can be selected. When the difference absolute value is equal to or smaller than the predetermined value, the frame reconfiguration method shown in FIG. 6A or FIG. 7A can be selected.

In the position of a thinned pixel of the present frame Fi, an average of difference absolute values can be calculated between values of same color pixels above and below the present frame Fi corresponding to the position of the thinned pixel and values of pixels of the past frame Fi−2 corresponding to the positions of the same color pixels above and below the present frame Fi. For example, in the position of the pixel P3 of the present frame Fi, a difference absolute value between a value of the pixel P5 of the present frame Fi and a value of the pixel P4 of the past frame Fi−2 is calculated, a difference absolute value between a value of the pixel P7 of the present frame Fi and a value of the pixel P6 of the past frame Fi−2 is calculated, and the difference absolute values are averaged.

When an inter-frame error used for frame reconfiguration is calculated, the method shown in FIG. 8 and the method shown in FIG. 9 can be combined. For example, a larger one of a value calculated by the method shown in FIG. 8 and a value calculated by the method shown in FIG. 9 can be used.

### Second Embodiment

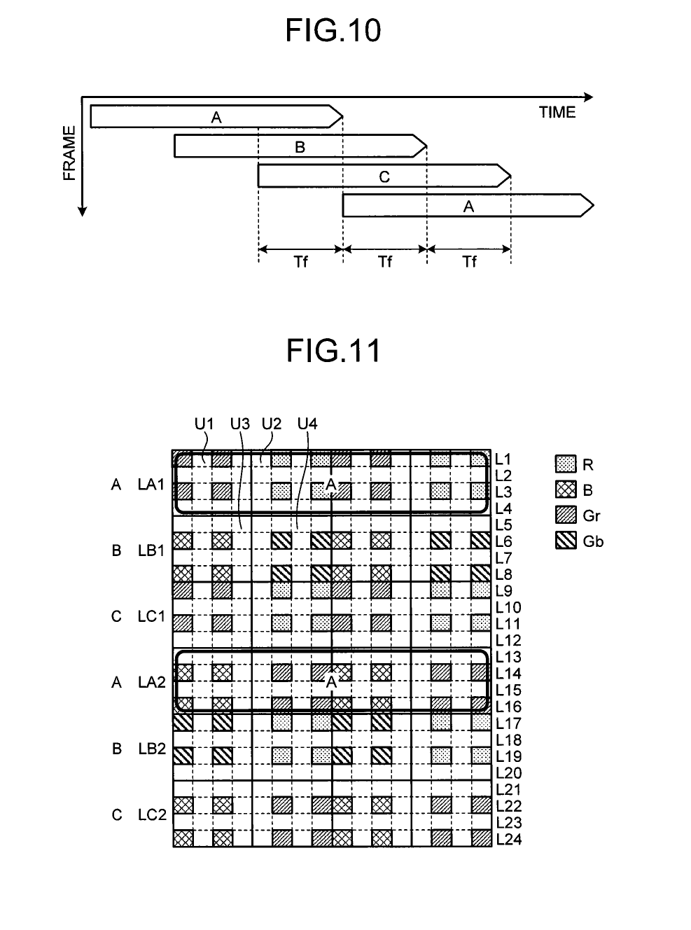

FIG. 10 is a diagram for explaining a frame read method of a solid-state imaging device according to a second embodiment. In an example shown in FIG. 10, a method of circulating space information at a cycle of three frames in a time direction is explained.

In FIG. 10, it is possible to triple a frame rate by sequentially reading frames A, B, and C in which the thinning positions are different. To make it easy to reconfigure one frame from the three frames A, B, and C, it is preferable that, as a pixel array of thinned one frame, all of RGB are aligned in the Bayer array. Further, it is preferable that phases in the Bayer array are aligned. When a read period for the frames A, B, and C is represented as Tf, exposure periods of the frames A, B, and C are set to 3 Tf. The exposure periods of the frames A, B, and C are set to overlap one another. Consequently, it is possible to triple sensitivity at the same frame rate.

### Third Embodiment

FIG. 11 is a diagram for explaining binning processing and a thinning read method of a solid-state imaging device according to a third embodiment.

In FIG. 11, in the frames A, B, and C, each of pixels U1 to U4 during read is configured by 4×4 pixels during exposure. In the pixel U1, the pixel for green Gb, the pixel for red R, and the pixel for blue B in the Bayer array HP are prevented from being read and only the pixel for green Gr is read. In the pixel U2, the pixels for green Gb and Gr and the pixel for blue B in the Bayer array HP are prevented from being read and only the pixel for red R is read. In the pixel U3, the pixels for green Gb and Gr and the pixel for red R in the Bayer array HP are prevented from being read and only the pixel for blue B is read. In the pixel U4, the pixel for green Gr, the pixel for red R, and the pixel for blue B in the Bayer array HP are prevented from being read and only the pixel for green Gb is read.

In the frame A, the lines L1 and L4 are read all together, whereby the line LA1 is read. The lines L13 to L16 are read all together, whereby the line LA2 is read. In the frame B, the lines L5 to L8 are read all together, whereby the line LB1 is read. The lines L17 to L20 are read all together, whereby the line LB2 is read. In the frame C, the lines L9 to L12 are read all together, whereby the line LC1 is read. The lines L21 to L24 are read all together, whereby the line LC2 is read.

The frames A, B and C are configured by the pixels U1 to U4. That is, in the frame A, the pixel for green Gr and the pixel for red R are read in the line LA1 and the pixel for green Gb and the pixel for blue B are read in the line LA2. In the frame B, the pixel for green Gb and the pixel for blue B are read in the line LB1 and the pixel for green Gr and the pixel for red R are read in the line LB2. In the frame C, the pixel for green Gr and the pixel for red R are read in the line LC1 and the pixel for green Gb and the pixel for blue B are read in the line LC2. Therefore, in the frames A, B, and C, a pixel array is the Bayer array. It is possible to make it easy to reconfigure one frame from the frames A, B, and C.

### Fourth Embodiment

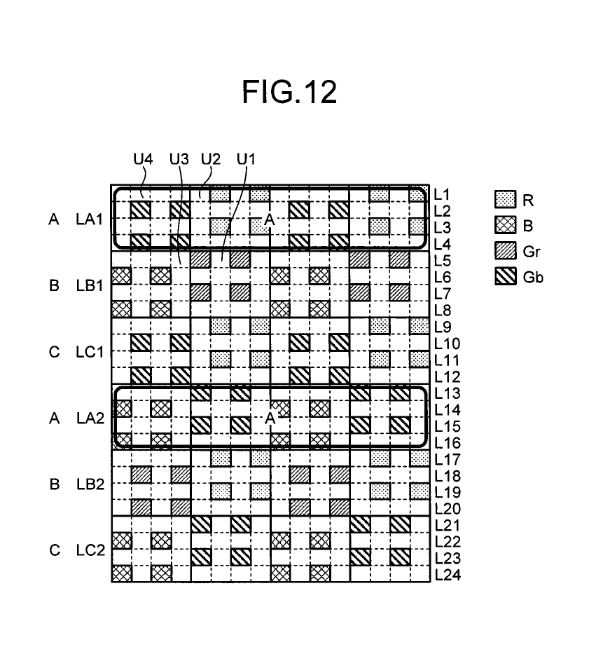

FIG. 12 is a diagram for explaining binning processing and a thinning read method of a solid-state imaging device according to a fourth embodiment.

In FIG. 12, in the frames A, B, and C, each of the pixels U1 to U4 during read is configured by 4×4 pixels during exposure. In the frame A, the lines L1 and L4 are read all together, whereby the line LA1 is read. The lines L13 to L16 are read all together, whereby the line LA2 is read. In the frame B, the lines L5 to L8 are read all together, whereby the line LB1 is read. The lines L17 to L20 are read all together, whereby the line LB2 is read. In the frame C, the lines L9 to L12 are read all together, whereby the line LC1 is read. The lines L21 to L24 are read all together, whereby the line LC2 is read.

In the frame A, the pixel for green Gb and the pixel for red R are read in the line LA1 and the pixel for green Gr and the pixel for blue B are read in the line LA2. In the frame B, the pixel for green Gr and the pixel for blue B are read in the line LB1 and the pixel for green Gb and the pixel for red R are read in the line LB2. In the frame C, the pixel for green Gb and the pixel for red R are read in the line LC1 and the pixel for green Gr and the pixel for blue B are read in the line LC2. Therefore, in the frames A, B, and C, it is possible to read signals from all columns while setting a pixel array as the Bayer array. It is possible to improve AD conversion speed compared with the method shown in FIG. 11 while making it easy to reconfigure a frame.

### Fifth Embodiment

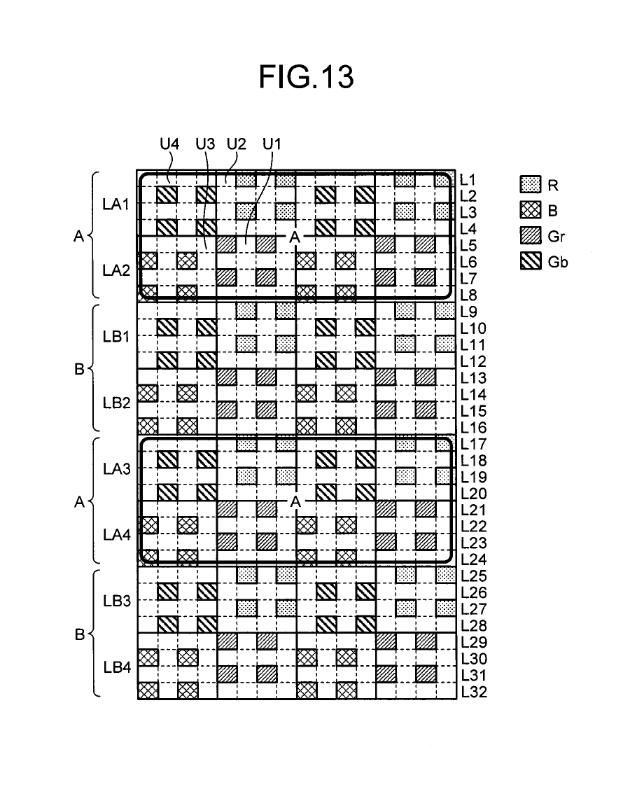

FIG. 13 is a diagram for explaining binning processing and a thinning read method of a solid-state imaging device according to a fifth embodiment.

In FIG. 13, in the frames A and B, each of the pixels U1 to U4 during read is configured by 4×4 pixels during exposure. In the frame A, the lines L1 and L4 are read all together, whereby the line LA1 is read. The lines L5 to L8 are read all together, whereby the line LA2 is read. The lines L17 to L20 are read all together, whereby the line LA3 is read. The lines L21 to L24 are read all together, whereby the line LA4 is read. In the frame B, the lines L9 to L12 are read all together, whereby the line LB1 is read. The lines L13 to L16 are read all together, whereby the line LB1 is read. The lines L13 to L16 are read all together, whereby the line LB2 is read. The lines L25 to L28 are read all together, whereby the line LB3 is read. The lines L29 to L32 are read all together, whereby the line LB4 is read.

In the frames A and B are configured by the pixels U to U4. That is, in the frame A, the pixel for green Gb and the pixel for red R are read in the lines LA1 and LA3 and the pixel for green Gr and the pixel for blue B are read in the lines LA2 and LA4. In the frame B, the pixel for green Gb and the pixel for red R are read in the lines LB1 and LB3 and the pixel for green Gr and the pixel for blue B are read in the lines LB2 and LB4. Therefore, in the frames A and B, a pixel array is the Bayer array and all phases are aligned. Therefore, it is possible to make it easy to reconfigure one frame from the frames A and B.

### Sixth Embodiment

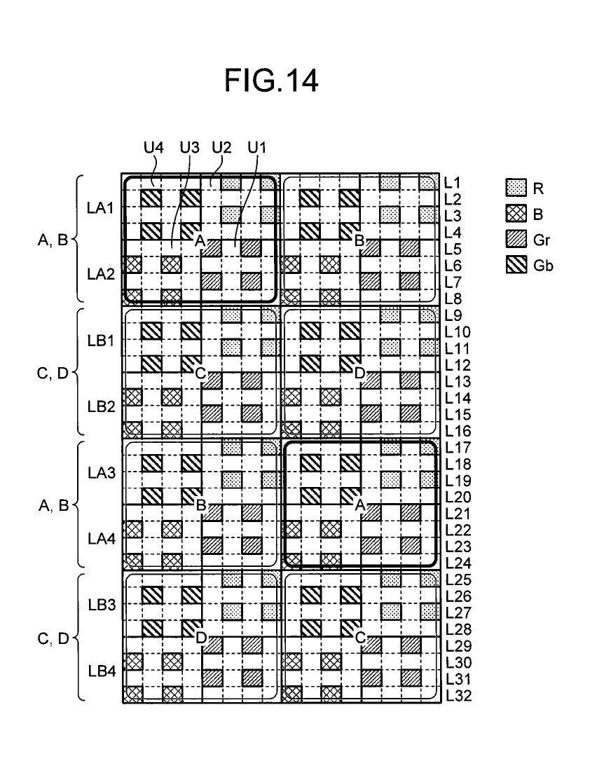

FIG. 14 is a diagram for explaining binning processing and a thinning read method of a solid-state imaging device according to a sixth embodiment.

In FIG. 14, in the frames A to D, each of the pixels U1 to U4 during read is configured by 4×4 pixels during exposure. The frames A and B are allocated to the same line and different columns. The frames C and D are allocated to the same line and different columns. The frames A and B and the frames C and D are allocated to different lines.

The frames A to D are configured by the pixels U1 to U4. Therefore, a pixel array is the Bayer array and all phases are aligned. Therefore, it is possible to make it easy to reconfigure one frame from the frames A to D.

### Seventh Embodiment

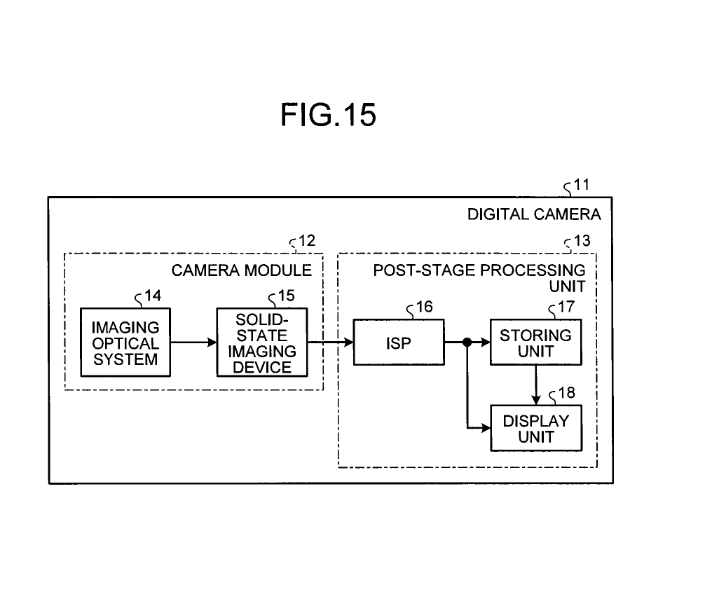

FIG. 15 is a block diagram of the schematic configuration of a digital camera applied with a solid-state imaging device according to a seventh embodiment.

In FIG. 15, a digital camera 11 includes a camera module 12 and a post-stage processing unit 13. The camera module 12 includes an imaging optical system 14 and a solid-state imaging device 15. The post-stage processing unit 13 includes an image signal processor (ISP) 16, a storing unit 17, and a display unit 18. As the solid-state imaging device 15, the configuration shown in FIG. 1 can be used. At least a part of components of the ISP 16 can be configured as one chip together with the solid-state imaging device 15. Alternatively, at least a part of components of the solid-state imaging device 15 can be configured as one chip together with the ISP 16. For example, the reconfiguration processing unit 8 can be provided in the ISP 16.

The imaging optical system 14 captures light from an object and images an object image. The solid-stage imaging device 15 picks up the object image. The ISP 16 subjects an image signal obtained by the image pickup in the solid-state imaging device 15 to signal processing. The storing unit 17 stores an image subjected to the signal processing in the ISP 16. The storing unit 17 outputs the image signal to the display unit 18 according to, for example, operation by a user. The display unit 18 displays the image according to the image signal input from the ISP 16 or the storing unit 17. The display unit 18 is, for example, a liquid crystal display. The camera module 12 can be applied to an electronic apparatus such as a portable terminal with a camera besides the digital camera 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit in which pixels configured to accumulate photoelectrically-converted charges are arranged in a matrix shape;
a binning control unit configured to perform control to lump together several pixels among the pixels between different lines of the pixel array unit;
a frame-read control unit configured to thin out and read the lines to vary thinning positions of the lines lumped together by the binning control unit among two or more frames; and
a reconfiguration processing unit configured to combine the two or more frames, in which the thinning positions are different, to thereby configure one frame.

2. The solid-stage imaging device according to claim 1, wherein the frame-read control unit reads the lines to vary thinning positions of the lines among M (M is an integer equal to or larger than 2) frames and, when an exposure period of one frame is represented as EX, reads the one frame in time of EX/M to make the exposure period to overlap an exposure period of a preceding frame in time of EX*(M−1)/M.

3. The solid-stage imaging device according to claim 1, wherein the binning control unit performs charge addition binning between different lines of the pixel array unit.

4. The solid-state imaging device according to claim 1, wherein
the pixels are formed in a Bayer array, and
binning, thinning, and reconfiguration are performed to maintain a correspondence relation among colors of the Bayer array.

5. The solid-state imaging device according to claim 4, wherein
the binning control unit performs control to lump together the pixels in every other one of the lines in each of the frames,
the frame-read control unit thins out every two lines of the lines lumped together by the binning control unit to continue each other, and
the reconfiguration processing unit alternately arranges the continuing two lines of the frames between frames in which the thinning positions are different.

6. The solid-state imaging device according to claim 1, wherein the solid-state imaging device performs charge addition binning in K (K is an integer equal to or larger than 2) lines, sets a number of frames, in which thinning positions are circulated, to M (M is an integer equal to or larger than 2), and sets exposure periods to overlap among the frames to multiply sensitivity with K×M and multiply an angle of view with K at a same frame rate.

7. The solid-state imaging device according to claim 1, wherein the solid-state imaging device performs charge addition binning in K (K is an integer equal to or larger than 2) lines, sets a number of frames, in which thinning positions are circulated, to M (M is an integer equal to or larger than 2), and sets exposure periods to overlap among the frames to multiply sensitivity with K, multiply an angle of view with K, and multiply a frame rate with M.

8. The solid-state imaging device according to claim 1, wherein the solid-state imaging device configures one pixel during read with 4×4 pixels during exposure and reads four lines all together during the exposure to configure a Bayer array with 2×2 pixels during the read.

9. The solid-state imaging device according to claim 8, wherein
the Bayer array during the read includes a first pixel, a second pixel, a third pixel, and a fourth pixel, and
only a first pixel for green of the Bayer array during the exposure is read during read from the first pixel, only a pixel for red of the Bayer array during the exposure is read during read from the second pixel, only a pixel for blue of the Bayer array during the exposure is read during read from the third pixel, and only a second pixel for green of the Bayer array during the exposure is read during read from the fourth pixel.

10. The solid-state imaging device according to claim 9, wherein the frame-read control unit simultaneously reads pixels adjacent to one another in a column direction of the Bayer array during the exposure.

11. The solid-state imaging device according to claim 1, wherein the solid-state imaging device properly uses, based on an inter-frame error, a reconfiguration method for increasing resolution and a reconfiguration method for reducing an artifact.

12. The solid-state imaging device according to claim 11, wherein the inter-frame error is a sum of difference absolute values between values of pixels of pixel regions respectively extracted from a past frame and a present frame.

13. The solid-state imaging device according to claim 12, wherein the solid-state imaging device selects, when the difference absolute value exceeds a predetermined value, the reconfiguration method for reducing the artifact and selects, when the difference absolute value is equal to or smaller than the predetermined value, the reconfiguration method for increasing the resolution.

14. The solid-state imaging device according to claim 12, wherein the solid-state imaging device calculates, in a position of a thinned pixel of the present frame, an average of difference absolute values between values of same color pixels above and below the present frame corresponding to the position of the thinned pixel and values of pixels of the past frame corresponding to positions of the same color pixels above and below the present frame.

15. The solid-state imaging device according to claim 1, wherein the reconfiguration processing unit interpolates a value of a thinned pixel of a present frame based on values of same color pixels above and below the present frame and a value of a pixel of a past frame corresponding to a position of the thinned pixel and converts a value of an original pixel of the present frame based on the value of the original pixel of the present frame and values of same color pixels above and below a pixel of the past frame corresponding to a position of the original pixel.

16. The solid-state imaging device according to claim 1, wherein the reconfiguration unit interpolates a value of a thinned pixel of a future frame based on a value of a pixel of a present frame corresponding to a position of the thinned pixel.

17. The solid-state imaging device according to claim 1, wherein the reconfiguration processing unit interpolates a value of a thinned pixel of a present frame based on values of pixels of a past frame and a future frame corresponding to a position of the thinned pixel.

18. The solid-state imaging device according to claim 1, further comprising:
a vertical scanning circuit configured to scan a read target pixel in a vertical direction;
a load circuit configured to perform a source follower operation with the pixel to thereby read a signal from the pixel to a vertical signal line for each of columns; and
a column ADC circuit configured to detect signal components of the pixels in a CDS for each of the columns.

19. The solid-state imaging device according to claim 1, wherein the pixel includes:
a photodiode configured to perform photoelectric conversion;
a readout transistor configured to transfer a signal from the photodiode to a floating diffusion;
a reset transistor configured to reset the signal accumulated in the floating diffusion; and
an amplifier transistor configured to detect potential of the floating diffusion.
